(19) United States
(12) Patent Application Publication
(10) Pub. No.: US 2011/0061259 A1
(43) Pub. Date: Mar. 17, 2011

(54) EXSICCATE DEVICE

(75) Inventor: Richard Pindell, Port Townsend, WA (US)

(73) Assignee: PINDELL ENGINEERING LLC, Port Townsend, WA (US)

(21) Appl. No.: 12/841,431

(22) Filed: Jul. 22, 2010

Related U.S. Application Data
(60) Provisional application No. 61/241,957, filed on Sep. 13, 2009.

(51) Int. Cl. F26B 25/06

(52) U.S. Cl. 34/201

(57) ABSTRACT

An exsiccate device removes moisture or water from a fuel tank. Suitably the fuel exsiccate device is interposed between two pipes that fluidically communicate air or fuel. The exsiccate device contains numerous beads formed from a substance that attracts water molecules via intermolecular forces, such as van der Waals forces, without being hygroscopic. The exsiccate device can be used to filter fuel directly by using numerous beads formed from molecular sieves that are suitably transition metal aluminosilicates with a substantially uniform pore crystalline structure.

### CROSS-REFERENCE TO A RELATED APPLICATION

The application claims the benefit of Provisional Application No. 61/241,957, filed Sep. 13, 2009, which is incorporated herein by reference.

### BACKGROUND

A fuel tank is a container for flammable liquids, but usually it refers to any storage tank for fuel that is part of an engine system in which the fuel is stored and communicated to an engine. When a vehicle, such as a boat or a motorcycle, is exposed to the elements, water eventually makes its way into the fuel tank. Water likely rusts the fuel tank, and, over time, rust may damage engine parts. Furthermore, any rust in the fuel lines, fuel filters, pumps, and so on, can cause continued damage to replacement engine parts. For vehicles that operate in cold environments, the temperature of the fuel in the tank decreases. Dissolved water in the fuel freezes, and pieces of ice may block fuel lines and cause other damage.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

One aspect of the subject matter includes a device form, which recites an exsiccate device. The exsiccate device comprises a cylindrical body made from a see-through material. The exsiccate device further comprises exsiccate beads disposed within the cylindrical body. The exsiccate device also comprises caps that enclose the cylindrical body at its terminals. Each cap finishes in a hole to allow fluid to be communicated to or from the cylindrical body.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1A is a pictorial diagram illustrating an archetypical exsiccate device in a marine environment;

FIG. 1B is a pictorial diagram illustrating an archetypical exsiccate device in an automotive environment;

FIG. 2 is an assembled, isometric view of an archetypical exsiccate device;

FIG. 3 is an exploded, isometric view of an archetypical exsiccate device;

FIG. 4 is a front view illustrating a cross-section of an archetypical exsiccate device;

FIG. 5 is an assembled isometric view of an archetypical exsiccate device; and

FIG. 6 is a pictorial diagram illustrating an archetypical exsiccate device in a marine environment.

### DETAILED DESCRIPTION

To prevent damage to fuel tanks, fuel lines, and engines in various environments, such as a marine environment or automotive environment, various embodiments of the present subject matter reduce or eliminate moisture from the air entering the fuel tank. Other embodiments reduce or remove water from the fuel tank. In various embodiments, an archetypical exsiccate device is interposed between vent lines, which provide openings for the communication of air for the relief of pressure inside the fuel tank. The exsiccate device reduces the water, thereby inhibiting rust, formation of ice, or bacterial growth, which may affect engine performance.

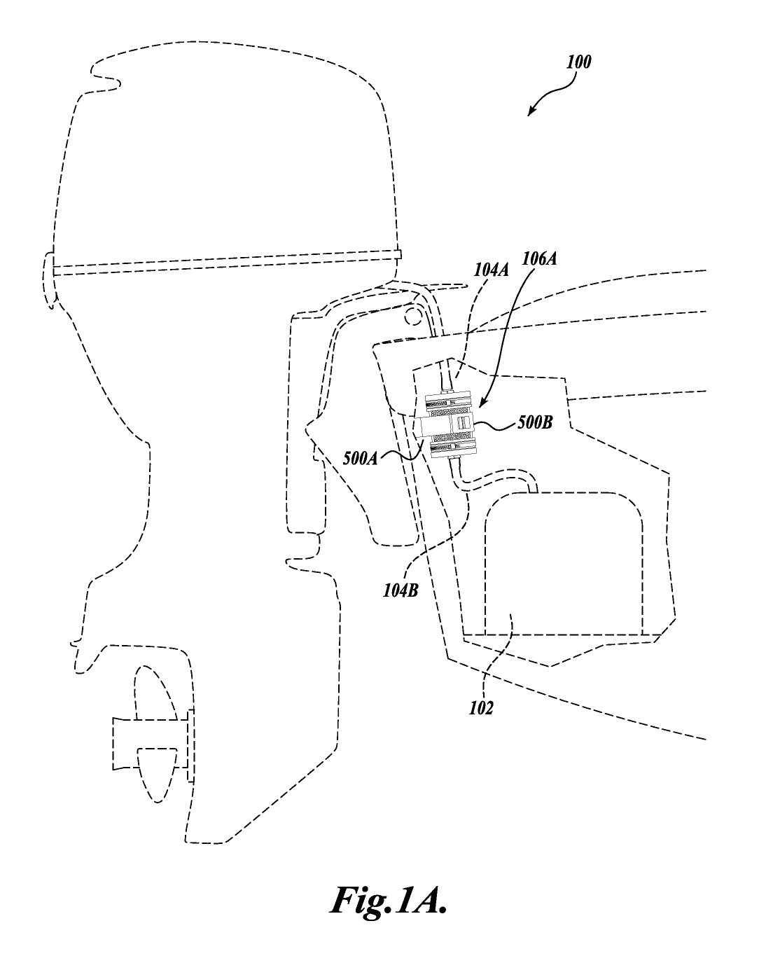

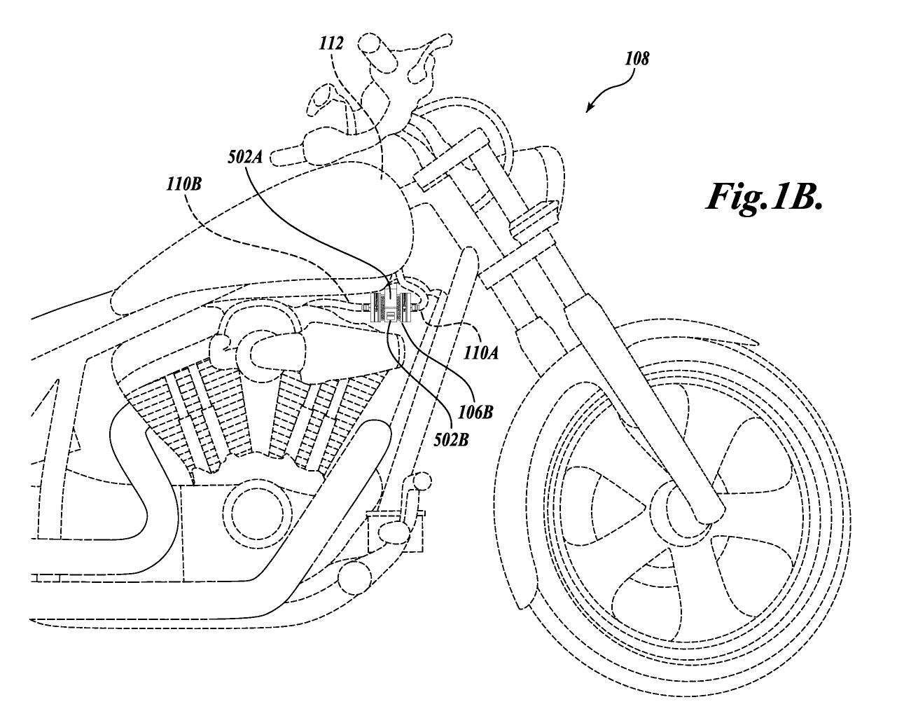

FIG. 1A is a pictorial diagram illustrating a stern of a boat 100. This illustration suggests the use of an exsiccate device in a marine environment. Attached to the boat's stern is an outboard motor, which is a small internal combustion engine with propeller integrally attached for mounting at the stern of the boat 100. As would be appreciated by one skilled in the art, various embodiments of the subject matter may be used in connection with engine setups in addition to the outboard motor as illustrated at FIG. 1A. A fuel tank 102, which is typically a large receptacle for holding or storing fuel, is disposed within proximity to the outboard motor. So as to equalize the pressure inside the fuel tank 102, tubes 104a, 104b couple the fuel tank 102 to an air vent (not shown). Interposed between the two tubes 104a, 104b is an exsiccate device 106a, which is mounted to the stern of the boat via a fastener 500a, which mates with its mechanical part 500b to fasten.

FIG. 1B illustrates a motorcycle 108. This illustration suggests the use of an exsiccate device in an automotive environment. A fuel tank 112 contains fuel, which is a volatile material used to produce power by burning. The fuel tank 112 is superjacently disposed to an engine block, which is a machine for receiving the fuel and converting it into mechanical force and resultant motion. As would be appreciated by one skilled in the art, various embodiments of the subject matter may be used in connection with engine setups in addition to the engine as illustrated at FIG. 1B. To equalize the pressure inside the fuel tank 112, tubes 110a, 110b couple the fuel tank 112 to an air vent (not shown). An exsiccate device 106b is interposed between the tubes 110a, 110b to remove moisture from the fuel tank 112. A fastener 502a grips the exsiccate device 106b, which mates with a mechanical part 502b to fasten.

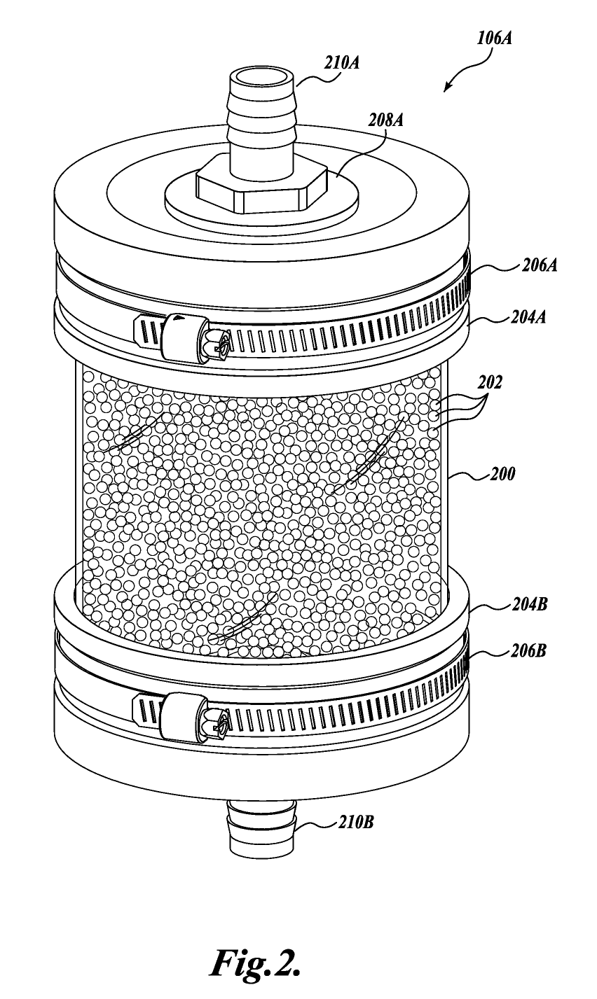

FIG. 2 illustrates an archetypical exsiccate device, such as the exsiccate device 106a, in greater detail. The exsiccate device 106a suitably includes a body 200 that has a suitable shape to contain exsiccate beads 202. Any suitable exsiccate beads 202 may be used. One suitable type of exsiccate beads 202 includes indicating silica gel, which turns bluish when substantially dry and pinkish when substantially adsorbed with water. The pinkish silica gel can be oven-dried for reuse. One suitable shape of the body 200 includes a cylindrical body, but other suitable shapes may be used. Suitably, the body 200 is formed from a see-through material, such as transparent acrylic. Caps 204a, 204b are fittings for enclosing terminals of the body 200. Suitably, the caps 204a, 204b are formed from a suitable elastic material, such as rubber. To secure the caps 204a, 204b to the terminals of the body 200, snares 206a, 206b, which comprise a perforated flat wire loop that finishes with a catch that suitably nooses around the periphery of the caps 204a, 204b to fasten the caps 204a, 204b to the terminals of the body 200.

At the end of each cap 204a, 204b, a washer 208a, 208b (not shown), which is a flat thin ring used to ensure tightness, is disposed. Superjacent or subjacent to the washers 208a, 208b are spout structures 210a, 210b, which comprise three portions. The distal portion is a cylinder whose external wall comprises a series of projections that obliquely incline away from the wall and away from the terminal of the distal end so as to form annular barb-like projections. The second portion is suitably shaped like a hexagonal nut that is disposed next to washer 208a, 208b (not shown). The external wall of the proximal end of the structure 210a, 210b disposes a projecting helical rib by which another mechanical part can be screwed to stay the spout structure 210a, 210b to the cap 204a, 204b.

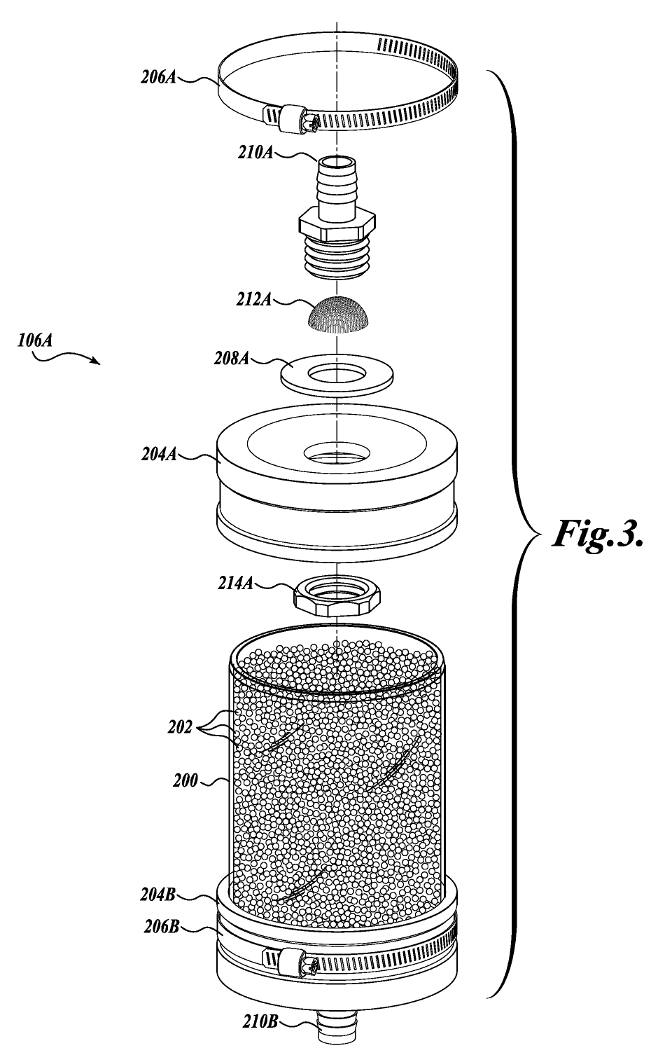

FIG. 3 illustrates portions of the exsiccate device 106a in exploded detail. At the top is the snare 206a, which comprises a perforated flat wire loop that finishes with a catch that suitably nooses around the periphery of the cap 204a to fasten the cap 204a to an upper terminal of the body 200. Suitably, the snare 206a, 206b is formed from a strong and flexible material, such as steel. The cap 204a, 204b suitably can be of any thickness. One suitable thickness includes ¼ inch. Next is the spout structure 210a featuring a distal portion (a cylinder whose external wall comprises a series of projections that obliquely incline away from the wall and away from the terminal of the distal end so as to form annular barb-like projections) that sits atop the hexagonal nut (the second portion) that is disposed next to washer 208a, and which finishes with the projecting helical rib (the proximal portion) by which a nut 214a can be screwed to stay the spout structure 210a to the cap 204a. A screen 212a is disposed under and in an internal wall of the proximal portion of the spout structure 210. The screen 212a is configured to confine the exsiccate beads 202a in the body 200. The amount of exsiccate beads 202a may vary depending on the volumetric capacity of the fuel tank. Next is the washer 208a, which is axially positioned over a hole in the center of the cap 204a. The hole allows fluid, liquid or gas, to be communicated to and from the exsiccate device 106a. Although not shown for brevity purposes, the bottom terminal of the body 200 is coupled to corresponding parts, such as the snare 206b, the cap 204b, the spout structure 210b, the washer 208b, a screen 212b, and so on.

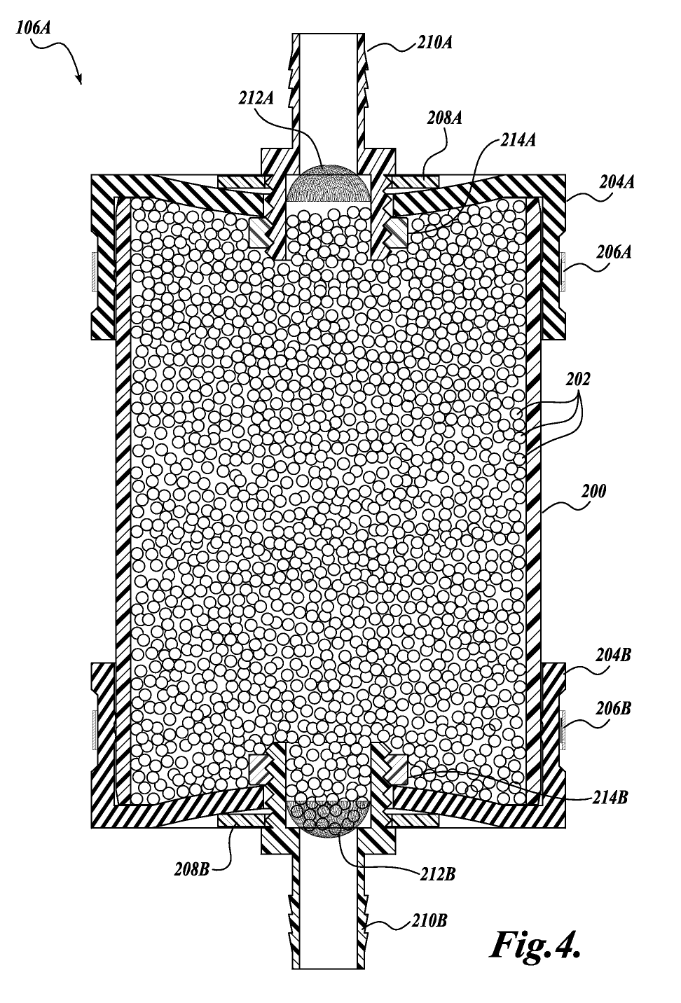

FIG. 4 is a cross-section of the assembled exsiccate device 106a. This view illustrates the fitting together of parts. The body 200 is filled with exsiccate beads 202. The body 200 suitably can be of any thickness. One suitable thickness includes ¼ inch. Enclosing both upper and lower terminals are the caps 204a, 204b. Securing the caps 204a, 204b to the upper and lower terminals are the snares 206a, 206b. Mating with the holes at the centers of the caps 204a, 204b are the proximal portions of the spout structures 210a, 210b. The convex surface of the screens 212a, 212b is disposed into the proximal portions of the spout structures 210a, 210b. The nuts 214a, 214b have complementary projecting helical ribs that can be screwed together with the projecting helical ribs of the proximal portions of the spout structures 210a, 210b to secure the spout structures 210a, 210b to the caps 204a, 204b. The washers 208a, 208b interpose between the second portion of the spout structures 210a, 210b and the caps 204a, 204b.

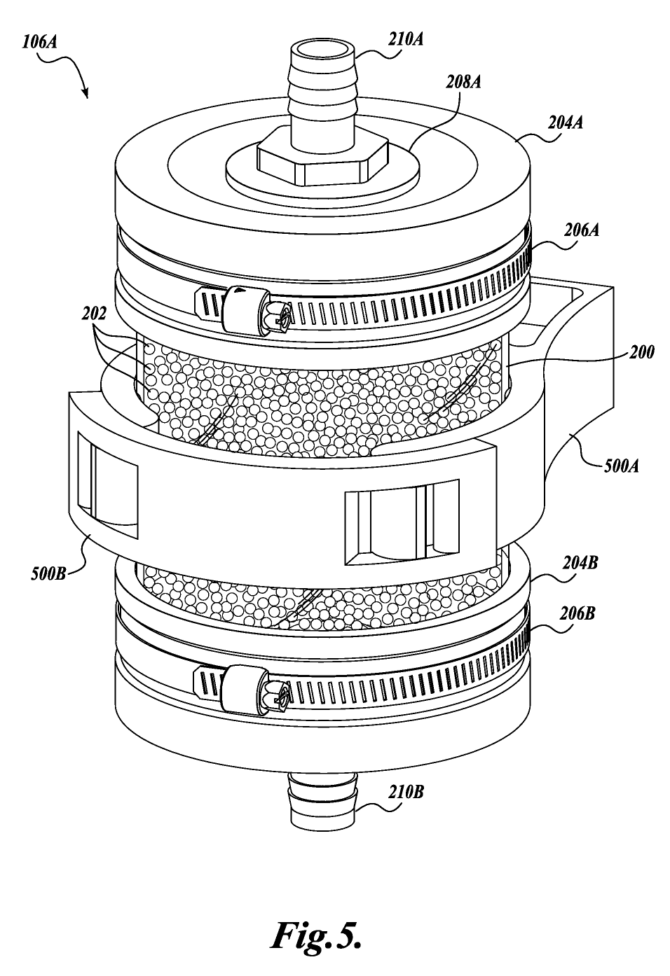

FIG. 5 illustrates the fastener 500a, which is configured in two portions. The first portion is a C-shaped clamp whose ends terminate in hooks. The second portion is a handle, which can be screwed to a wall. The mechanical part 500b is a curved bar whose distal and proximal ends have rectangular openings through which the hooks of the C-shaped clamp of the fastener 500a may engage to secure the exsiccate device 106a. As would be appreciated by one with ordinary skill in the art, other suitable fastener mechanisms may be used to secure the exsiccate device 106a besides the one illustrated here.

Because various embodiments of the present subject matter operate on an adsorption principle, the placement of the exsiccate device 106a is unlikely to drip water back into the fuel tank because the water molecules are bonded to the surface of the exsiccate beads 202. Moreover, given the molecular bonds, the water molecules are unlikely to freeze or expand to cause damage to the fastener 500a or other parts of a boat or a motor vehicle.

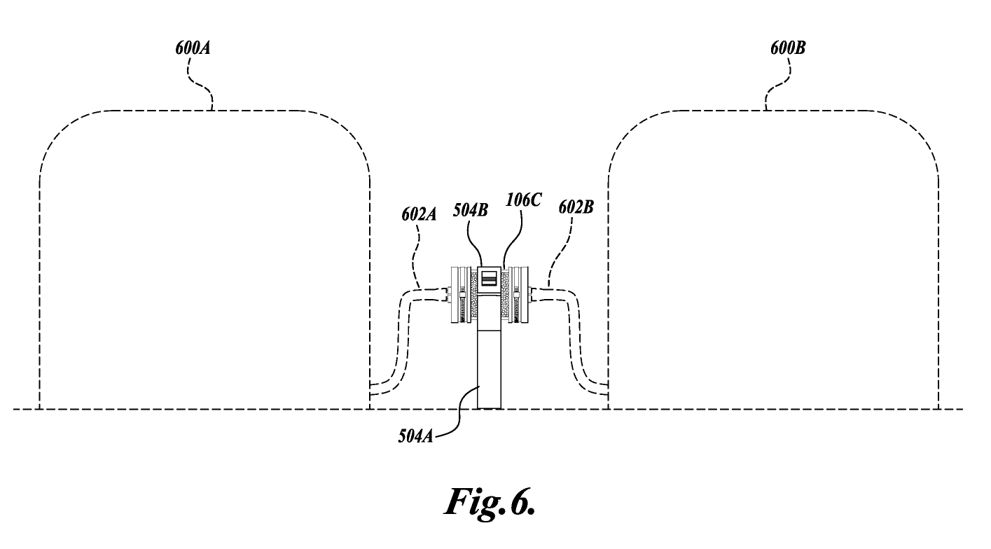

FIG. 6 illustrates two fuel tanks 600a, 600b. Interposed between the two fuel tanks 600a, 600b is another embodiment of the exsiccate device 106c, which are in fluid communication with the two fuel tanks 600a, 600b via tubes 602a, 602b. The exsiccate device 106c is secured via the fastener 504a and its mating mechanical part 504b. In embodiments where water has converted from the vapor state to the denser liquid state that mixes with the fuel in a fuel tank, such as the fuel tank 600a, the fuel from the fuel tank 600a can be communicated to the fuel tank 600b to allow the exsiccate device 106c to remove the condensed water from the fuel. In those embodiments, suitably, the exsiccate beads are molecular sieves.

Molecular sieves are suitably selected from a group consisting of transition metal aluminosilicates with a substantially uniform pore crystalline structure. Suitably, the molecular sieves operate on a size exclusion principle. Smaller sized molecules that fit into the pores are adsorped while larger molecules are passed through. Molecular sieves suitably have substantial pore openings selected from a group consisting of three, four, five, or ten Angstroms. Polarity of the molecules affects adsorption since highly polarized molecules are likely to be adsorbed more readily into the pores, whereas non-polarized molecules are not as readily adsorped.

While illustrative embodiments have been illustrated and described, it will be appreciated that various changes can be made therein without departing from the spirit and scope of the invention.

1. An exsiccate device, comprising:
a cylindrical body made from a see-through material;
exsiccate beads disposed within the cylindrical body; and
caps that enclose the cylindrical body at its terminals, each cap finishing in a hole to allow fluid to be communicated to or from the cylindrical body.

2. The exsiccate device of claim 1, wherein the hole of the cap is axially located.

3. The exsiccate device of claim 1, further comprising a spout structure in three portions, one of the portions being a proximal end whose external wall has a projecting helical rib by which another mechanical part can be screwed to stay the spout structure to the cap.

4. The exsiccate device of claim 3, wherein the spout structure includes another portion which is a distal portion configured as a cylinder whose external wall comprises a series of projections that obliquely incline away from the wall and away from the terminal of the distal end so as to form annular barb-like projections.

5. The exsiccate device of claim 4, wherein the spout structure includes a third portion which is shaped like a hexagonal nut.

6. The exsiccate device of claim 5, further comprising a washer through which the proximal end of the spout structure is inserted so that the washer abuts the third portion.

7. The exsiccate device of claim 6, wherein the proximal end of the spout structure is configured to insert through the hole, which is caused to stay to the cap by a nut whose complementary projecting helical ribs can be screwed together with the projecting helical ribs of the proximal end of the spout structure.

8. The exsiccate device of claim 3, further comprising a screen configured for insertion into an inner wall of the proximal end of the spout structure.

9. The exsiccate device of claim 1, further comprising snares for securing the caps to the cylindrical body.
